(19) United States
(12) Patent Application Publication
(10) Pub. No.: US 2018/0139096 A1
(43) Pub. Date: May 17, 2018

(54) COMPOSITION CONSTRAINTS FOR NETWORK POLICIES

(71) Applicant: Hewlett Packard Enterprise Development LP, Houston, TX (US)

(72) Inventors: Jeongkeun Lee, Mountain View, CA (US); Yoshio Turner, San Francisco, CA (US); Sujata Banerjee, Palo Alto, CA (US)

(21) Appl. No.: 15/574,270

(22) PCT Filed: May 15, 2015
(86) PCT No.: PCT/US2015/030973

§ 371 Date: Nov. 15, 2017

(51) Int. Cl. H04L 12/24; H04L 29/06

(52) U.S. Cl. CPC H04L 41/0893; G06T 11/206; H04L 63/20

(57) ABSTRACT

Each network policy of network policies specifies at least one characteristic of communications allowed between endpoint groups, each endpoint group of the endpoint groups including at least one endpoint. The network policies are merged according to composition constraints included in the network policies.

### BACKGROUND

A network can be used to communicate data between various endpoints. The network can include interconnecting devices (e.g. routers, switches, etc.) for forwarding data along respective paths between endpoints. In addition, various service functions can be implemented with service function boxes deployed in the network, where the service functions can be applied on data packets communicated along paths in the network.

### BRIEF DESCRIPTION OF THE DRAWINGS

Some implementations are described with respect to the following figures.

FIGS. 1A-1D are graphs representing corresponding different example network policies that can be provided to govern communications in a network, according to some examples.

FIG. 2 is a flow diagram of an example process according to some implementations.

FIG. 3 is a schematic diagram of composing a composite policy graph from input policy graphs that include edge types representing different composition constraints, according to some examples.

FIGS. 4A-4B are graphs illustrating an example of merging network policies to form a composite network policy, according to some implementations.

FIG. 5 is a block diagram of an example system that incorporates a graph composer according to some implementations.

FIG. 6 is a block diagram of an example arrangement that includes a system incorporating a graph composer, and a system incorporating a runtime controller, according to some implementations.

FIG. 7 is a block diagram of an example system that incorporates a policy editor according to some implementations.

### DETAILED DESCRIPTION

Network policies can be provided for governing communications of data in a network. As used here, the term “network” can refer to an arrangement of devices and paths that allow for communications between endpoints. Examples of endpoints include a server, a virtual machine, a client device, a subnet, an end user, and so forth. In some cases, in examples where there are multiple networks that are coupled to each other, a network can also be considered an endpoint. More generally, an endpoint can be a smallest unit of abstraction for which a network policy is applied.

A network policy can specify at least one characteristic of communications allowed between endpoint groups (EPGs), where each endpoint group (EPG) includes one or multiple endpoints. Examples of characteristics that can be specified by a network policy include port numbers to use for communications between respective EPGs, one or multiple service functions to apply to data that is communicated between respective EPGs, and/or other characteristics. A port number can refer to a Transmission Control Protocol (TCP) port number. Stated differently, a network policy can specify a behavior of a portion of a network in processing data (e.g. data packets). The processing of data packets can include forwarding data packets, modifying data packets (such as by changing values of headers of the data packets, dropping the data packets, etc.), applying service functions, and/or other types of processing.

Examples of service functions, which can be implemented by service function boxes, include load balancing to balance data communication load across multiple devices, protection services (such as firewall protection, intrusion detection, network authorization or authentication, etc.), network address translation (to translate an address of a data packet between a first address and a second address), and/or other service functions. A service function box can refer to a hardware device or a program (machine-readable or machine-executable instructions) configured to perform a respective service function.

Different network policies can be provided by respective different policy writers. Examples of policy writers can include network administrators, service providers, network operators, application developers, tenants of a cloud infrastructure, and so forth. A cloud infrastructure can refer to an arrangement of resources (including processing resources, storage resources, and/or other resources) that are available over a network to devices of tenants (which are users that are able to selectively access the cloud resources). Network policies can also be provided by automated entities, such as control programs, applications, network services, and so forth. Thus, a policy writer can refer to any entity (a human, a machine, or a program) that is able to provide a network policy.

In some examples, network policies can be provided by multiple different policy writers in the context of Software Defined Networking (SDN). SDN can refer to a technique for implementing computer networking environments using software (or more generally, machine-readable or machine-executable instructions) to control the configuration and allocation of networking resources in the network. In such a network, the hardware resources (e.g. routers, switches, server, etc.) or virtual network and compute resources (e.g. virtual layer 2/layer 3 (L2/L3) networks, virtual machines) can be programmed to allocate networking and computing resources according to the network policies of various policy writers.

Network policies can be expressed using any of various different programming languages. In some examples, as discussed in the present disclosure, network policies can be represented using graphs.

As the number of independent network policies provided by policy writers increase, the management of communications in a network can become more complex, due to possible conflicts between the network policies. Given a collection of network policies from respective policy writers, a composite network policy can be produced by merging the network policies. Merging network policies can involve combining the network policies while accounting for any conflicts between the network policies. To properly merge multiple network policies into a composite network policy (a process referred to as network policy composition), an understanding of the intents of respective policy writers in formulating respective network policies is first determined. Manually merging network policies (particularly a large number of network policies) can be time and labor intensive, and may result in incorrect composition of the network policies or production of a composite network policy that is inconsistent with an intent of a policy writer.

In accordance with some implementations of the present disclosure, composition constraints can be specified in network policies, where the composition constraints capture respective intents of policy writers with respect to communications allowed by the corresponding network policies. A number of different composition constraints can be specified, and these composition constraints can be used in identifying and resolving conflicts between network policies when performing network policy composition. In some implementations of the present disclosure, the composition constraints can be represented using different types of edges in policy graphs that represent the corresponding network policies.

A policy graph (or more simply “graph”) can include vertices that represent respective EPGs, and an edge between the vertices represent allowed communications between the EPGs (or more specifically, communications between endpoints of the EPGs). An EPG can refer to a group of arbitrary addressable endpoints or a group of endpoints that can perform a common logical role or share a common property (also referred to as a “label”). An EPG includes endpoints that satisfy a membership predicate specified for the EPG. A membership predicate can be provided as a label (any endpoint with a given label is a member of a given EPG). In general, a membership predicate can be provided as a Boolean expression over labels—for example, if a Boolean expression containing at least one given label of an endpoint evaluates to true, then the endpoint is a member of a respective EPG.

Endpoints are addressable using Internet Protocol (IP) addresses, Media Access Control (MAC) addresses, virtual local area network (VLAN) identifiers, and/or other types of addresses.

Endpoint properties (labels) can be assigned and changed dynamically at runtime, to cause respective endpoints to change membership between different EPGs. In response to an endpoint changing membership from a first EPG to a second EPG, the network policy that can be applied on communications of the endpoint can change from a first network policy (associated with the first EPG) to a second network policy (associated with the second EPG). As a result, changing an endpoint property can cause different network policies to be dynamically assigned to an endpoint as the endpoint property changes over time.

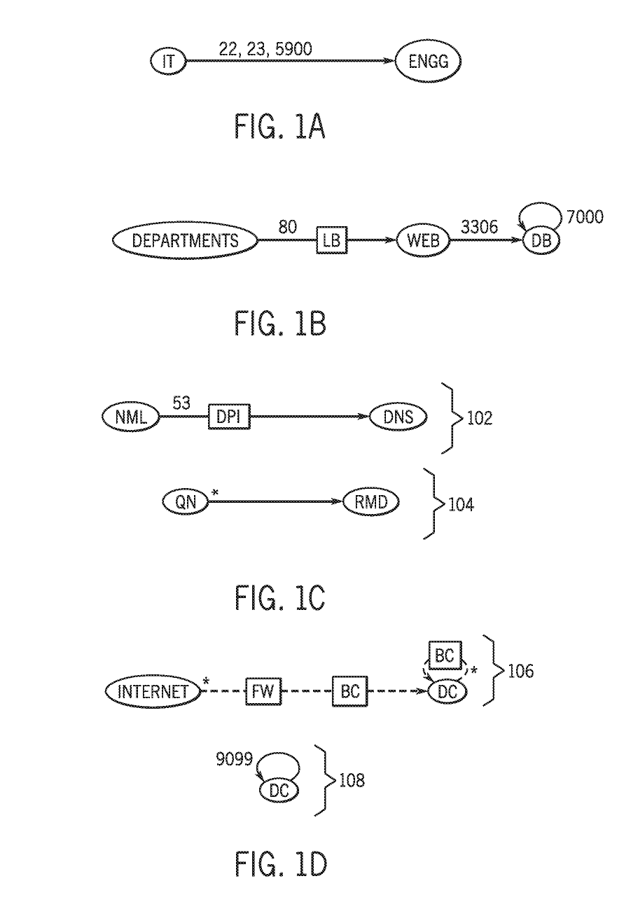

FIGS. 1A-1D illustrate examples of policy graphs (or more simply “graphs”) that are used to represent respective example network policies. FIG. 1A is a graph representing a first example network policy provided by an administrator for departments of an enterprise. The graph of FIG. 1A includes an IT vertex that represents an IT department (first EPG) and an ENGG vertex that represents an engineering department (second EPG). An edge between the IT vertex and the ENGG vertex indicates that traffic is allowed from any endpoint of the IT department to any endpoint of the engineering department using specified protocol port numbers (22, 23, or 5900 in the example of FIG. 1A).

FIG. 1B is a graph representing a second example network policy provided by a web application administrator. The graph of FIG. 1B includes a Departments vertex (representing a first EPG including departments of an enterprise), a Web vertex (representing a second EPG including one or multiple Web applications), and a DB vertex (representing a third EPG including one or multiple databases). An edge between the Departments vertex and the Web vertex in the graph of FIG. 1B specifies that traffic is allowed from any department to access a Web application using port 80 in the example, and also specifies that the traffic is to be load balanced using a load balancer (LB) service function box. An edge between the Web vertex and the DB vertex specifies that traffic is allowed from a Web application to a database tier, using port 3306 in the example. The graph of FIG. 1B also shows an edge from the DB vertex to itself, which allows a database within the database tier to communicate with another database using port 7000 in the example.

FIG. 1C is a graph representing a third example network policy provided by an SDN application for domain name system (DNS)-based security protection. The graph of FIG. 1C includes a first graph model 102 having an NML vertex (representing an EPG including endpoints having a “normal” security status) connected over an edge having a deep packet inspection (DPI) service function box to a DNS vertex (an EPG including one or multiple DNS servers). The first graph model 102 specifies that traffic from the NML EPG to the DNS EPG is allowed if the traffic uses port 53, and further specifies that DPI is to be applied on the traffic.

The graph of FIG. 1C further includes a second graph model 104 having a QN vertex (representing an EPG including endpoints that have a “quarantined” status) connected over an edge to an RMD vertex (representing an EPG that includes one or multiple security remediation servers). The “*” indication on the edge in the second graph model 104 indicates that the traffic from the QN EPG to the RMD EPG is allowed for any port number. The network policy represented by the graph of FIG. 1C specifies that DNS traffic from network endpoints with the “normal” security status is be inspected by a DPI service function box when DNS lookups of DNS server(s) are performed. The network policy represented by the graph of FIG. 1C also specifies that network endpoints that have the “quarantined” status can only send their traffic (of any type) to a security remediation server in the RMD EPG.

FIG. 1D is a graph representing a fourth example network policy provided by a data center administrator. The graph of FIG. 1D includes a first graph model 106 and a second graph model 108. The first graph model 106 specifies that traffic coming into a data center (represented by the DC vertex) from the Internet (represented by the Internet vertex) can use any port number (indicated by the “*”) and is to pass through a firewall (FW) service function box (that provides firewall protection) and a byte counter (BC) service function box (that counts a number of bytes of data). In addition, the first graph model 106 includes an edge, including a byte counter (BC) service function box, from the DC vertex to itself, which specifies that traffic within the data center also traverses the BC service function box.

The second graph model 108 allows monitoring of traffic (on port 9099 in the example) between endpoints in the data center.

Although example policy graphs representing respective example network policies are depicted in FIGS. 1A-1D, it is noted that there can be other network policies represented by other policy graphs.

Each of the example network policies shown in FIGS. 1A-1D specify access control whitelisting (ACL), which grants specific entities access rights to other entities if a specified condition is satisfied. An edge of each policy graph in FIGS. 1A-1D can thus be referred to as an access control whitelisting edge, which provides an access control whitelisting rule. In addition, FIGS. 1B-1D represent network policies that specify service function chaining, in which one or multiple service functions are included in an edge to apply to data.

As noted further above, endpoints can be assigned labels dynamically at runtime, causing the endpoints to move from one EPG to another EPG. For example, a server that was assigned the label NML (“normal” status) can subsequently be relabeled QN (“quarantined” status) when a network monitor detects the server issuing a DNS query for a known malicious Internet domain.

Thus, a policy graph (such as any of those depicted in FIGS. 1A-1D) can represent a set of one or multiple network policies that are applied dynamically to each endpoint according to the endpoint's status changes over time. Moreover, note that the composition of network policies represented by graphs into a composite network policy is performed only in response to changes in network policies, such as when a network policy is added, modified, or removed. The composition of network policies does not have to be performed in response to a change in membership of an endpoint from one EPG to another EPG. Instead, a runtime system only has to perform a relatively lightweight operation of looking up and applying the respective network policies for each endpoint depending on the endpoint's current EPG membership.

Each of the graphs shown in FIGS. 1A-1D includes a directed edge that specifies allowed communication from any endpoint in a source EPG to any endpoint in a destination EPG. Each edge can be associated with a classifier, which matches packet header fields of a data packet to determine the respective network policy (e.g. an access control whitelisting rule) is to be applied. For example, in FIG. 1A, the classifier associated with the edge between the IT vertex and the ENGG vertex determines if values of the packet header fields of a packet indicate that a source of the packet is an endpoint in the IT department, a destination of the packet is an endpoint in the engineering department, and a port number of 22, 23, or 5900 is used. Stated differently, the classifier compares the values of the packet header fields (e.g. source address field, destination address field, port number field) of the packet to corresponding values (e.g. source address value, destination address value, port number value) of the respective network policy to determine if a match condition of the edge is satisfied. If the match condition of the edge is satisfied as determined by the classifier, then communication of the packet from the IT department endpoint to the engineering department endpoint is allowed.

In some implementations, by default, no communication is allowed between EPGs without an associated edge.

An access control whitelist rule of a network policy can be stateful, such that the reverse traffic on an established connection (e.g. a TCP connection) is also allowed.

Although FIGS. 1A-1D depict a single edge between respective pairs of EPG vertices, it is noted that there can be multiple directed edges from a first EPG vertex to a second EPG vertex, where each edge is associated with a respective different classifier.

In some examples of the present disclosure, two general types of edges can be specified. An access control whitelist edge is depicted as a solid line (such as a solid line in FIG. 1A, 1B, or 1C) and describes an allowed communication between EPGs. A conditional edge is depicted as a dotted line (such as the dotted line between the Internet vertex and the DC vertex and the dotted line from the DC vertex to itself in FIG. 1D) and can specify conditional application of a service function chain (including one or multiple service function boxes) if and only if the conditional edge's match condition overlaps a match condition of an access control whitelist edge in another policy graph. Stated differently, the service function chain of the conditional edge (of a first network policy) between a first EPG and a second EPG is applied if there is another network policy that specifies that the communications between the first and second EPGs are allowed under the same conditions as the first network policy.

For example, in FIG. 1D, the conditional edge from the Internet EPG to the DC EPG specifies that, if another policy graph contains an access control whitelist edge allowing communication from the Internet EPG to the DC EPG, then the service function chain of FIG. 1D (including the FW service function box and the BC service function box) is applied in a composite network policy that is composed from at least the network policy of FIG. 1D and the network policy of the other policy graph.

In some example implementations, a service function box can represent an abstract function that takes a packet as input and returns a set of zero or more packets. In such implementations, a network programming language can be used to describe the function, behaviors, and properties of a service function box. In various implementations, a Pyretic network programming language can be used. Pyretic can use real IP/MAC addresses to implement network programs. Pyretic can be extended to write programs/policies regarding logical EPG parameters (e.g. ‘web.ip’ to indicate IP addresses of a Web EPG). Examples of functions that can be provided by Pyretic programs include a drop function (to drop packets), a forward function (to forward a packet), and so forth.

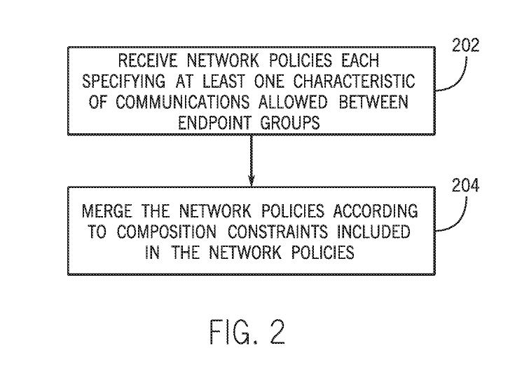

FIG. 2 is a flow diagram of a process according to some implementations, which can be performed by a policy composer. The policy composer receives (at 202) network policies, where each network policy specifies at least one characteristic of communications allowed between EPGs, and each EPG includes at least one endpoint. In some implementations, the policy composer receives policy graphs that are representations of the respective network policies.

The policy composer merges (at 204) the network policies according to composition constraints included in the network policies. In some implementations, merging the network policies can be performed by combining the policy graphs that represent the respective network policies.

The composition constraints can include the following, according to some implementations of the present disclosure:
A composition constraint that specifies that communications between respective EPGs must be allowed.
A composition constraint specifying that communications between respective EPGs can be allowed.
A composition constraint specifying that communications between respective EPGs are to be blocked.
A composition constraint included in a first network policy and specifying at least one service function to be conditionally applied to communications between respective EPGs, if and only if another network policy specifies that the communications between the respective EPGs are allowed.

The policy composer is able to combine multiple independently specified policy graphs (representing respective network policies) into a coherent composed policy based on the composition constraints included in the policy graphs. It is noted that the policy composer is also able to also merge chains of service function boxes, as discussed further below.

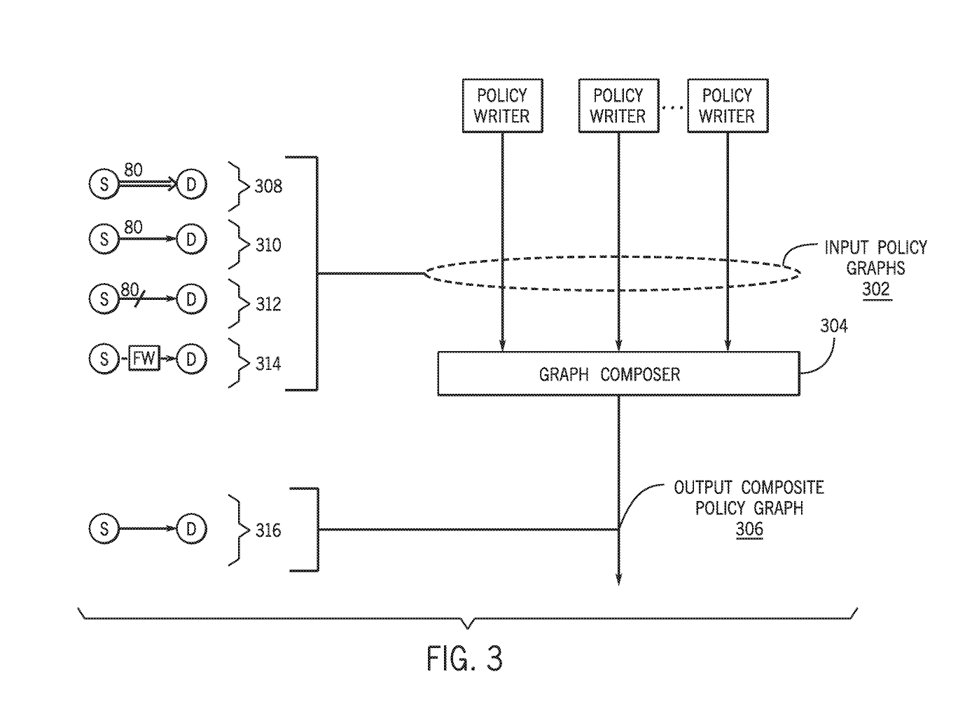

FIG. 3 is a schematic diagram depicting composition of input policy graphs 302 (representing respective network policies) from respective policy writers by a graph composer 304 (which is an example of the policy composer discussed above) into a composite policy graph 306. The composition constraints that can be included in input policy graphs 302 governing communications between a particular source EPG (S) and a particular destination EPG (D) can be represented by respective different edge types 308, 310, 312, and 314.

The edge type 308 (including an arrow with double solid lines) represents a composition constraint that specifies that communications between the source EPG (S) and the destination EPG (D) must be allowed. The edge type 310 (including an arrow with single solid line) represents a composition constraint specifying that communications between the source EPG and the destination EPG can be allowed. The edge type 312 (including an arrow with a diagonal line crossing through the arrow) represents a composition constraint specifying that communications between the source EPG and the destination EPG are to be blocked. The edge type 314 (including a dotted arrow and having at least one service function box, e.g. FW box) represents a composition constraint included in a first network policy and specifying at least one service function to be conditionally applied to communications between the source EPG and the destination EPG, if and only if another network policy specifies that the communications between the source EPG and the destination EPG are allowed

In some implementations, a must edge (edge type 308) or a can edge (edge type 310) overrides a conditional edge (edge type 314), while a block edge (edge type 312) overrides a can edge (edge type 310). The must edge or can edge of a first network policy overriding the conditional edge of a second network policy can refer to allowing the communications between the source EPG and the destination EPG, subject to application of the service function chain (including one or multiple service function boxes) of the conditional edge of the second network policy. The block edge overriding the can edge can refer to blocking communications between the source EPG and the destination EPG according to a first network policy, even though a second network policy allows the communications between the source EPG and the destination EPG.

A conflict between a must edge in a first network policy and a block edge in a second network policy is resolved based on ranks assigned to the first and second network policies or ranks assigned to the policy writers of the first and second network policies. For example, if the first network policy is ranked higher than the second network policy, the must edge of the first network policy overrides the block edge of the second network policy, such that communications between the source EPG and the destination EPG are allowed pursuant to the first network policy, even though the second network policy specifies that such communications are to be blocked. In the foregoing example, the second network policy is considered to be a dropped network policy, since the second network policy has been disregarded. A dropped network policy can be reported to a target entity, such as a policy writer or some other entity.

In other cases, if the ranks of the first and second network policies are the same, then the conflict between the first and second network policies remains unresolved. In such case, the unresolved conflict can be reported to a target entity, such as a policy writer or other entity for resolution, revision, and possible re-submission.

After composition of the input policy graphs 302 into the composite policy graph 306 that considers the composition constraints represented by the edge types 308, 310, 312, and 314, a resultant graph 316 for communications between the source EPG and the destination EPG is provided, which has an arrow with a single solid line to indicate that the communications between the source EPG and the destination EPG is allowed. Although not shown in FIG. 3, it is noted that the FW service function box of the edge type 314 can be added to the resultant graph 316 to indicate that the FW service function is to be applied in the composite policy graph 306.

In addition to specifying composition constraints as discussed above, service chain constraints can also be specified. In some implementations, there can be several different types of service chain constraints. A first type service chain constraint can set restrictions on the behavior of service function boxes that are added to a resultant service function chain produced from combining service function chains of input the policy graphs. For example, a first type service chain constraint can set a restriction on packet header field modifications and packet drop operations that respective service function boxes can perform on packets. Composition analysis performed by the graph composer 304 can check whether adding a specific service function box to a given service chain would violate first type service chain constraints given by input policy graphs that are being composed together.

Table 1 below shows example first type service chain constraints for communications from a source EPG to a destination EPG.

TABLE 1

Service Function Box

| Match | Can drop packets | Can modify packets |
|---|---|---|
| Port 80 | N | DSCP = 16, 18, 20 |
| * | | |

The first type service chain constraints of Table 1 indicate that a service function box added to an edge from the source EPG to the destination EPG that uses port 80 edge cannot drop packets but is allowed to modify a differentiated services code point (DSCP) packet field to values in a specified set of specific values (e.g. 16, 18, 20 in Table 1). As an example, the edge from the source EPG to the destination EPG of a first input policy graph can include three service function boxes (boxes A, B, C) in sequence, which means that when the first input policy graph is combined with a second input policy graph, a service function box of the second input policy graph can be added to one of four positions in the edge from the source EPG to the destination EPG. The four positions include: (1) a position before box A, (2) a position between boxes A and B, (3) a position between boxes B and C, and (4) a position after box C. One or multiple first type service chain constraints are applicable to service function box(es) that can be added to one of the four possible positions.

Second type service chain constraints can specify restrictions on a change characteristic of a given service function box that is already present on the edge from the source EPG to the destination EPG. A change characteristic of a service function box indicates whether or not the service function box can be changed (e.g. dropped or modified) in a certain way. Examples of second type service chain constraints include (1) a service chain constraint specifying whether the given service function box can or cannot be dropped, and (2) a service chain constraint specifying whether the given service function box can or cannot be modified. If the second type service chain constraint specifies that the given service function box cannot be dropped, then the given service function box has to remain on (i.e. cannot be removed from) the edge from the source EPG to the destination EPG in the composite policy graph. Similarly, if the second type service chain constraint specifies that the given service function box cannot be modified, then the given service function box on the edge from the source EPG to the destination EPG cannot be changed.

Although just two types of service chain constraints are discussed, it is noted that there can be additional or alternative types of service chain constraints.

In some further implementations of the present disclosure, an atomic sub-chain can also be specified on the edge from the source EPG to the destination EPG. An atomic sub-chain includes at least two service function boxes, and does not allow for the insertion of another service function in the atomic sub-chain. The service function boxes of the atomic sub-chain can share a common second type constraint(s); in other words, the second type constraint(s) is (are) associated with the atomic sub-chain at the granularity of the atomic sub-chain, rather than individually with the service function boxes in the atomic sub-chain.

In some examples, service chain constraints can be specified using a constraint language such as Prolog or another language.

In further implementations, a special composition constraint can be provided to specify that traffic to or from a particular EPG has to follow a specific behavior of a given network policy. For example, the particular EPG can be marked with an “exclusive” flag in a first network policy, which prevents another network policy from overriding the first network policy that specifies that traffic to or from the particular EPG follow a specific behavior. For example, in the model 104 of FIG. 1C, the QN EPG can be marked with the exclusive flag, to preventing other network policies from thwarting the intention of the policy writer of the network policy of FIG. 1C to redirect all traffic from quarantined endpoints to a remediation server.

The following describes policy graph composition as performed by the graph composer 304 according to some implementations. The use of the graph composer 304 allows policy writers to specify their network policies independently and delegate the composition process to the graph composer 304. In some examples, the graph composer 304 can produce a composite policy graph that: 1) satisfies the maximum set of network policies represented by input policy graphs without violating the composition constraints of the network policies, and 2) includes just mutually exclusive EPGs. By including just mutually exclusive EPGs (in other words, no two EPGs share any common endpoint), a runtime system can determine a unique EPG for a given endpoint, such that the associated network policies (associated with the unique EPG) can be applied to the given endpoint.

Note that if a particular endpoint is not part of any EPG, then no communication is allowed for the particular endpoint.

In performing policy graph composition, the graph composer 304 combines EPGs, and merges network policies. As EPGs can have overlapping endpoint membership (specified as arbitrary Boolean expressions over the label space of labels that can be assigned to respective endpoints), the graph composer 304 is able to separate input EPGs into an equivalent set of disjoint EPGs. The graph composer 304 can also compute directed edges equivalent to the union of edges in the input network policies, except where doing so would violate composition constraints.

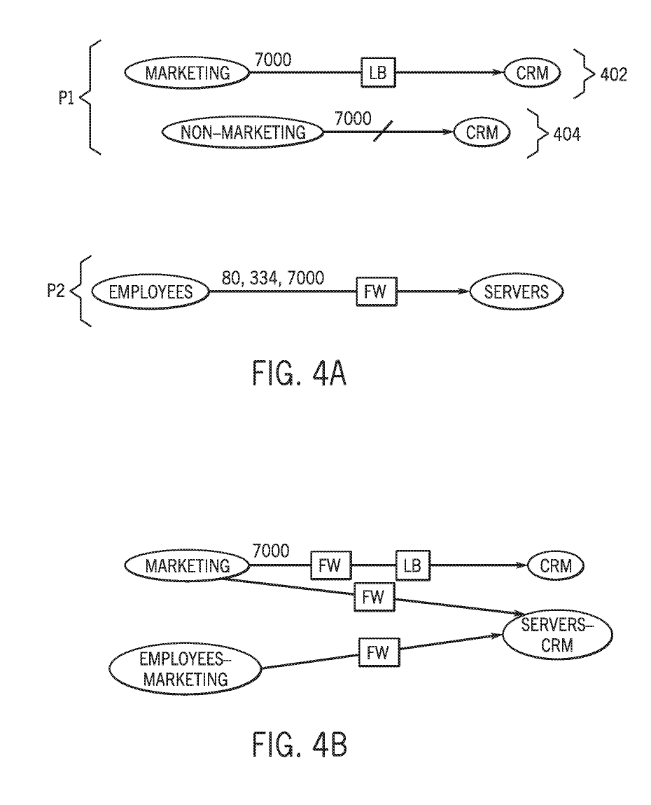

FIG. 4A depicts two example policy graphs P1 and P2 (representing respective network policies) that are to be combined by the graph composer 304. The policy graph P1 has a graph model 402 specifying that endpoints in a marketing EPG are allowed to access a customer relationship management (CRM) EPG (including one or multiple CRM servers). The edge between the marketing vertex and the CRM vertex specifies that port 7000 is to be used, and that a load balancing (LB) service function box is to be applied on the traffic between the marketing EPG and the CRM EPG.

The policy graph P1 also includes another graph model 404 including an edge according to the block edge type (edge type 312 in FIG. 3) between a non-marketing EPG and the CRM EPG. The block edge type specifies that traffic of endpoints in the non-marketing EPG (endpoints that are not in the marketing EPG) to the CRM EPG is blocked.

The policy graph P2 specifies that endpoints of an employees EPG can access endpoints of a servers EPG using ports 80, 334, and 7000, and that the traffic passes through a firewall (FW) service function. Note that endpoints of the marketing EPG are a subset of the employees EPG, and the endpoints of the CRM EPG are a subset of the servers EPG. Note also that the port range (port 7000) of the policy graph P1 is a subset of the port range (ports 80, 334, 7000) of the policy graph P2. As a result, the EPGs and port range of the policy graph P1 are completely encompassed by the EPGs and the port range in the policy graph P2

Since the EPGs and port range of the policy graph P1 are completely encompassed by the EPGs and the port range in the policy graph P2, one may naively compose the access control whitelisting rules of the policy graphs P1 and P2 by prioritizing P1 over P2, but this would incorrectly allow traffic of non-marketing EPG endpoints to reach endpoints of the CRM EPG. In addition, it can be assumed that the intended order of the service function chain is FW followed by LB, so that the graph composition would have to consider this intended order.

By using the graph model 404 in the policy graph P1, the intent of the policy writer of the policy graph P1 that traffic of endpoints of non-marketing employees to CRM servers are to be blocked can be captured and considered by the graph composer 304. Note that the access control whitelisting rules of the policy graphs P1 and P2 conflict since P1 blocks non-marketing employees' traffic to CRM servers, while P2 allows the traffic from all employees (including non-marketing employees) to all servers (including CRM servers). By including the composition constraint represented by the graph model 404 in the policy graph P1, the conflict can be resolved by overriding P2's policy to allow non-marketing employees to access CRM servers with the composition constraint in the policy graph P1 that blocks traffic of non-marketing employees to the CRM servers.

An example composite policy graph based on combining the policy graphs P1 and P2 is shown in FIG. 4B. In the composite policy graph of FIG. 4B, the {Employees—Marketing} vertex represents an EPG made up of non-marketing employees, and the {Servers—CRM} vertex represents an EPG made up of non-CRM servers. Also, in the composite policy graph of FIG. 4B, the order of the FW-LB chain between the marketing EPG and the CRM EPG complies with the intended order of the FW and LB service functions.

In combining the service function chain (including FW) of the policy graph P2 with the service function chain (including LB) of the policy graph P1, to provide FW-LB chain between the marketing EPG and the CRM EPG of the composite policy graph of FIG. 4B, the graph composer 304 can determine the proper order of the service function boxes by detecting dependencies between the service function boxes based on analysis of the boxes' packet processing functions. Detected dependencies are used to determine valid orderings.

Also, in forming the service function chain in the composite policy graph produced by the graph composer 304, the graph composer 304 also considers any service chain constraints as discussed above, wherein each service chain constraint can set restrictions on the behavior of service function boxes that are added in the composite policy graph.

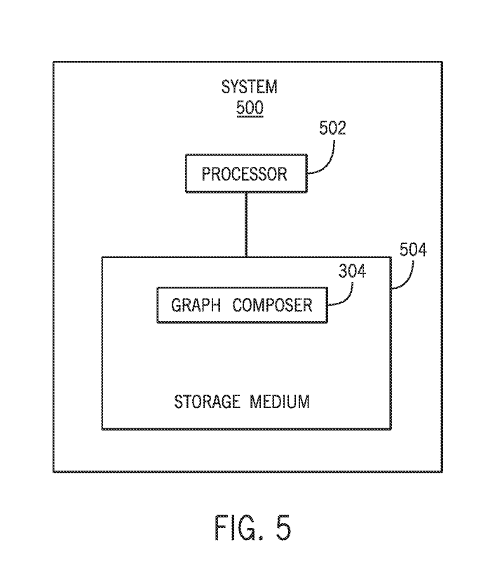

FIG. 5 is a block diagram of a system 500 according to some implementations. The system 500 can include a computer or an arrangement of multiple computers. The system 500 includes a processor (or multiple processors) 502, which can be coupled to a non-transitory machine-readable or computer-readable storage medium (or storage media) 504. A processor can include a microprocessor, a microcontroller, a physical processor module or subsystem, a programmable integrated circuit, a programmable gate array, or another physical control or computing device.

The storage medium (or storage media) 504 can store the graph composer 304, which can be implemented as machine-readable instructions that are executable on the processor(s) 502 to perform various tasks as discussed above, including those depicted in FIGS. 2, 3, and 4A-4B.

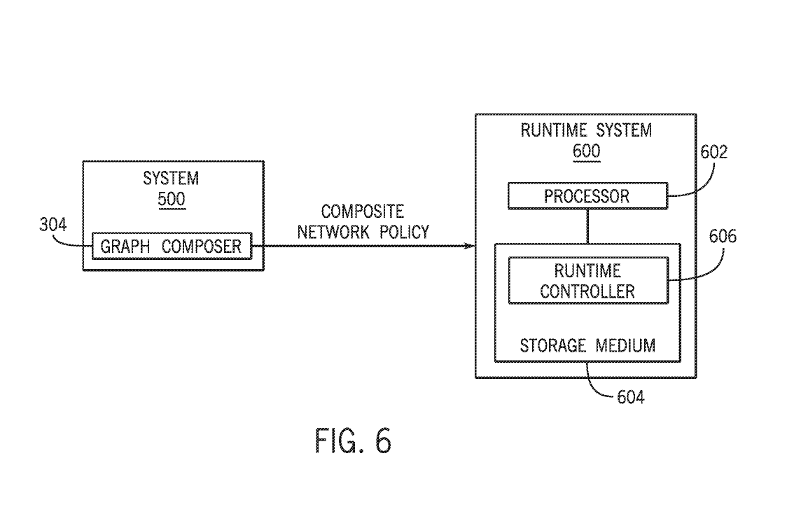

FIG. 6 is a block diagram of an arrangement that includes the system 500 (in which the graph composer 304 is executable) and a runtime system 600 that is able to receive a composite network policy (which can be in the form of a composite policy graph) produced by the graph composer 304. from the system 500. Note that the runtime system 600 can receive multiple network policies from the graph composer 304.

The runtime system 600 includes a processor (or multiple processors) 602, which can be coupled to a non-transitory machine-readable or computer-readable storage medium (or storage media) 604. The storage medium (or storage media) 604 can store a runtime controller 606, which can be implemented as machine-readable instructions that are executable on the processor(s) 602 to perform various tasks.

For example, the runtime controller 606 is able to render a high-level composite policy graph (provided by the graph composer 304) into low-level device configurations (such as configurations of switches in a network) to enforce the respective network policies. In some examples, the low-level configurations can be expressed as OpenFlow rules enforced using an SDN controller, which is an example of the runtime controller 606.

The SDN controller can operate according to an OpenFlow protocol, as described in the OpenFlow Switch Specification, provided by the Open Networking Foundation. The OpenFlow rules derived from the composite policy graph can be used to configure flow tables in switches of a communication network. A switch uses its flow table (or flow tables) to determine how packets are to be processed and forwarded by the switch.

In other examples, the runtime controller 606 can derive other types of network control rules from a received composite policy graph for configuring switches or other types of communication devices in a network.

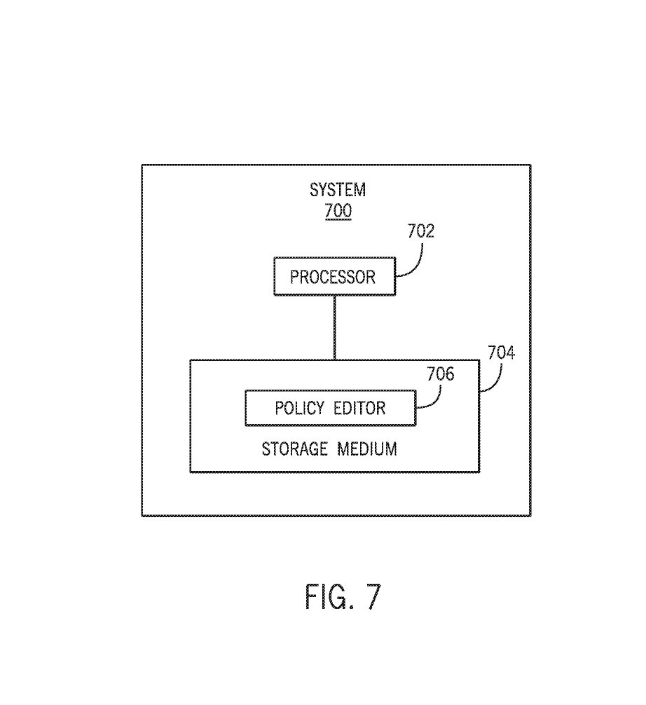

FIG. 7 is a block diagram of a system 700 according to some implementations. The system 700 can include a computer or an arrangement of multiple computers. The system 700 includes a processor (or multiple processors) 702, which can be coupled to a non-transitory machine-readable or computer-readable storage medium (or storage media) 704. The storage medium (or storage media) 704 can store a policy editor 606, which can be implemented as machine-readable instructions that are executable on the processor(s) 702 to allow a policy writer to create a network policy, such as in the form of a policy graph that includes composition constraints and/or service chain constraints as discussed above.

The policy editor 606 can define a network policy for communications between EPGs. The policy editor 606 can include a composition constraint (and/or a service chain constraint) in the network policy, where the composition constraint is for use in merging the network policy with at least another network policy.

The policy editor 606 can present a user interface (such as a graphical user interface) to allow a policy writer to create a network policy.

Data and instructions are stored in respective storage devices, which are implemented as one or multiple non-transitory computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system comprising a processor, network policies, each network policy of the network policies specifying at least one characteristic of communications allowed between endpoint groups, each endpoint group of the endpoint groups including at least one endpoint; and
merging, by the system, the network policies according to composition constraints included in the network policies, the composition constraints comprising a first composition constraint specifying that communications between respective endpoint groups must be allowed.

2. The method of claim 1, wherein the merging comprises:
resolving a conflict between a first network policy of the network policies that includes the first composition constraint and a second network policy of the network policies that includes another composition constraint of the composition constraints.

3. The method of claim 1, wherein the composition constraints according to which the network policies are merged further comprise a second composition constraint specifying that communications between respective endpoint groups are to be blocked.

4. The method of claim 3, wherein the merging comprises:
resolving a conflict between a first network policy of the network policies that includes the first composition constraint and a second network policy of the network policies that includes the second composition constraint, based on rankings of the first and second network policies or rankings of policy writers of the first and second network policies.

5. The method of claim 3, wherein the composition constraints according to which the network policies are merged further comprise a third composition constraint included in a first network policy and specifying at least one service function to be conditionally applied to communications between respective endpoint groups of a set if a second network policy specifies that the communications between the respective endpoint groups of the set are allowed.

6. The method of claim 5, wherein the merging comprises:
resolving a conflict between a third network policy of the network policies that includes the first composition constraint and the first network policy of the network policies that includes the second composition constraint, wherein the conflict is resolved by overriding the first network policy with the third network policy.

7. The method of claim 5, wherein the composition constraints according to which the network policies are merged further comprise a fourth composition constraint specifying that communications between respective endpoint groups can be allowed.

8. The method of claim 1, further comprising:
representing each network policy of the network policies as a graph; and
representing the composition constraints in the graphs using different types of edges between respective endpoint groups.

9. The method of claim 1, wherein the merging is further based on a service function box constraint specifying a constraint on behavior of at least one service function box added to a path between endpoint groups, the at least one service function box to apply a service function.

10. The method of claim 9, wherein the merging is further based on a second service function box constraint specifying a constraint on a change characteristic of at least one service function box existing on the path between endpoint groups.

11. The method of claim 10, wherein the second service function box constraint is associated with an atomic sub-chain that includes the at least one service function box existing on the path between endpoint groups.

12. A system comprising:
at least one processor to:
receive graphs representing respective network policies, each network policy of the network policies specifying at least one characteristic of communications allowed between endpoint groups, each endpoint group of the endpoint groups including at least one endpoint, wherein a first graph of the graphs includes a first type of edge representing a first composition constraint specifying that communications between respective endpoint groups are to be blocked, and a second graph of the graphs includes a second, different type of edge representing a second composition constraint different from the first composition constraint; and
combine the graphs into a composite graph representing a composite network policy, wherein the combining is according to composition constraints included in the network policies, the composition constraints comprising the first composition constraint represented by the first type of edge, and the second composition constraint represented by the second type of edge.

13. The system of claim 12, wherein the second composition constraint specifies that communications between respective endpoint groups must be allowed.

14. The system of claim 12, wherein the composition constraints further comprise a third composition constraint included in a first network policy and specifying at least one service function to be conditionally applied to communications between respective endpoint groups of a set if a second network policy specifies that the communications between the respective endpoint groups of the set are allowed.

15. An article comprising at least one non-transitory machine-readable storage medium storing instructions that upon execution cause a system to:
define a network policy for communications between endpoint groups, each endpoint group of the endpoint groups including at least one endpoint; and
including a composition constraint in the network policy, the composition constraint for use in merging the network policy with at least another network policy, and the composition constraint specifying that the communications between the endpoint groups must be allowed.
